(19) United States
(12) Patent Application Publication
(10) Pub. No.: US 2008/0116746 A1
(43) Pub. Date: May 22, 2008

(54) SELF-POWERED ELECTRICAL SYSTEM

(75) Inventor: David A. Hein, Sterling Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/560,967

(22) Filed: Nov. 17, 2006

(51) Int. Cl. H02J 1/02; E05B 17/22

(52) U.S. Cl. 307/10.1; 320/101; 320/128; 320/166

(57) ABSTRACT

The embodiments described herein include an electrical system and method for providing electrical energy. In one embodiment, an energy conversion device is configured to produce electrical energy from at least one of vibrations or movement experienced by the energy conversion device. An energy storage device is configured store the electrical energy. Additionally, an electrical device is coupled to the energy storage device and is configured to receive the electrical energy and transmit a signal to a receiving device to perform a desired function.

### TECHNICAL FIELD

The embodiments described herein relate to a self-powered system and method for providing electrical energy.

### BACKGROUND

Conventionally, the supply of electrical energy to systems and sub-systems occurs through the use of a power source (e.g., a battery) that supplies electrical energy to electrical components/devices such as sensors, switches, modules and the like. The power source is typically coupled to the electrical components via physical wires. In the context of a vehicle, the use of wires to couple electrical components is costly and effects system reliability. Furthermore, the design and assembly of vehicles utilizing conventional wiring schemes and power sources to supply electrical energy is impacted. Accordingly, the embodiments described herein were conceived in view of these and other disadvantages of vehicles having conventional power sources and wiring arrangements.

### SUMMARY

The embodiments described herein include an electrical system and method for providing electrical energy. The system includes an energy conversion device configured to produce electrical energy from at least one of vibrations or movement experienced by the energy conversion device. An energy storage device is coupled to the energy conversion device and stores the electrical energy. Additionally, an electrical device is coupled to the energy storage device and is configured to receive the electrical energy and transmit a signal to a receiving device.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a block diagram of an electrical system for providing electrical energy in accordance with an embodiment of the present invention;

FIG. 2 illustrates a non-limiting embodiment of the electrical system of FIG. 1 being located on a vehicle; and

FIG. 3 illustrates a flow chart of a method for providing electrical energy in accordance with an embodiment of the present invention.

### DETAILED DESCRIPTION OF THE PREFERRED EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

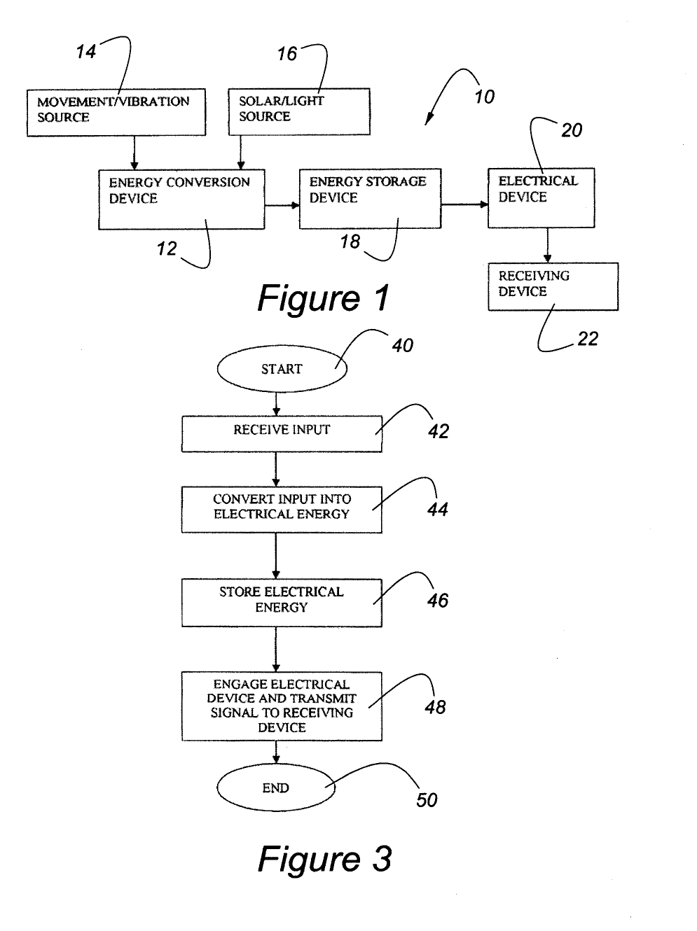

Referring to FIG. 1, an electrical system 10 is shown that is configured to provide electrical energy. Electrical system 10 includes an energy conversion device 12, an energy storage device 18, an electrical device 20 and a receiving device 22. Energy conversion device 12 is configured to receive inputs from a plurality of sources and convert the inputs into electrical energy. For example, as shown, a movement/vibration source 14 and a solar/light source 16 provide inputs into energy conversion device 12. It is recognized that alternative sources may be utilized without departing from the present invention. For example, energy conversion device 12 may be adapted to receive electromagnetic interference (EMI) inputs and thermal inputs, and convert these inputs into a form of energy (e.g., electrical energy) that is suitable for electrical system 10.

As stated above, energy conversion device 12 is adapted to receive inputs from, for example, a movement/vibration source 14 and a solar/light source 16. Movement/vibration source 14 may be any component, device, object and the like configured to cause movement and/or vibration of energy device 12. For example, in the context of a vehicle, movements or vibration of the vehicle may serve as an input into energy conversion device 12. In response, energy conversion device 12 is configured to convert this “vibrational” energy into electrical energy.

To enable energy conversion device 12 to convert movement/vibrations into electrical energy, it may include a piezoelectric element. The piezoelectric element may include a piezoelectric material (e.g., PZT-lead zirconate titanate) that operates to convert the movement and/or vibration experienced by the device into an electrical voltage and current. In some aspects of the present invention, energy conversion device 12 may convert momentum experienced by the device into electrical energy. In such an embodiment, an accelerometer may be integrated with energy conversion device 12 for detecting the acceleration and/or velocity of energy conversion device 12. Based on the mass of the object (e.g., a vehicle) to which the energy conversion device 12 is attached and the velocity, the momentum may be determined and converted into electrical energy by energy conversion device 12.

In some embodiments, energy conversion device 12 may include the PMG7 vibration energy harvesting device available from Perpetuum Ltd., Epsilon House, Southampton Science Park, Southampton, SO16 7NS. The PMG7 contains magnetic and coil arrangements that enable transformation of kinetic energy resulting from vibration/movement into an electrical signal based on Faraday's principle. It is recognized that in some embodiments, energy conversion device 12 may also be implemented utilizing micro electromechanical silicon (MEMS) technology to integrate the energy conversion device components onto a unitary electronic chip. It is recognized that MEMS can be used to form electronic components such as switches, navigational compasses, relays, RF transmitters and the like.

Regarding solar/light source 16, it may be a solar panel or any device configured to receive light and provide a corresponding input into energy conversion device 12. As recognized by one of ordinary skill in the art, the solar panel may contain arrays of solar cells that convert light into electricity. It is recognized that the in some embodiments the solar panels may be integrated with energy conversion device 12, so as to enable it to convert light into electricity.

Once energy conversion device 12 has converted the received inputs into electrical energy, the electrical energy is received by an energy storage device 18. Energy storage device 18 may be a capacitor (e.g., an ultra-capacitor), a battery or any device configured to store electrical energy. As such, even in the event that energy conversion device 12 has not received any inputs for conversion into electrical energy, energy storage device 18 serves as a power source for the remaining devices of electrical system 10. Thus, electrical system 10 is adapted to provide electrical energy even in the event that there is a lack of inputs for conversion into electrical energy by energy conversion device 12. Once energy storage device 18 receives and stores the electrical energy, this energy is available for use by electrical device 20.

In one embodiment, electrical device 20 includes a switch such as a door switch to operate a sliding door or a liftgate on a vehicle. Additionally, when electrical device 20 is embodied as a switch, it may be utilized as a dome light switch, a heating ventilation and air conditioning (HVAC) control switch, an audio switch and the like. Alternatively, electrical device 20 may be a sensor, such as a vehicle sensor. In some aspects of the present invention, electrical device 20, being embodied as a sensor may be a low fluid level sensor, a seat position sensor and the like. Once electrical device 20 is engaged/activated, it is configured to transmit signals to receiving device 22. It is recognized that although the foregoing examples are related to vehicles, the described embodiments may be equally adapted for non-vehicle applications without departing from the scope of the present invention.

In one embodiment, the transmission of signals from electrical device 20 to receiving device 22 is through the use of a physical wire. Alternatively, transmissions from electrical device 20 to receiving device 22 may be through the use of a radio-frequency (RF) signal. In such an embodiment, electrical device 20 would include an RF transmitter that transmits a signal to receiving device 22 when engaged/activated. It is recognized that a variety of wireless communication protocols may be utilized including, but not limited to, wi-fi, Bluetooth® and the like.

Receiving device 22 may be a receiver and/or module such as those commonly installed on a vehicle. For example, receiving device 22 may be a vehicular door module that enables the opening and/or closing of a vehicle door. Receiving device 22 may also be a keyless entry module that is operable with a vehicular key pad for locking and/or unlocking a vehicle door. It is recognized however, that receiving device 22 may be virtually any type of device, for non-vehicles and vehicles alike, that is adapted to receive signals from electrical device 20 and perform or cause a desired function.

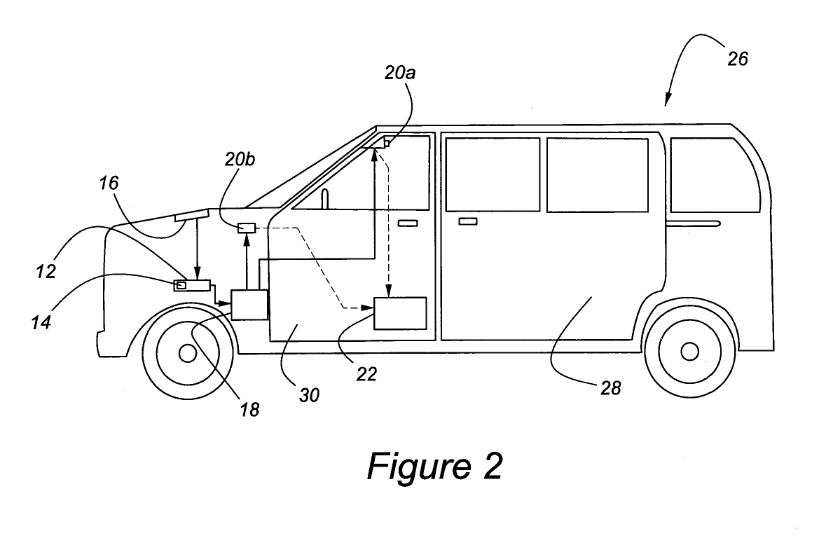

Now, referring to FIG. 2, a non-limiting embodiment of electrical system 10 is shown being implemented on a vehicle 26. Vehicle 26 includes solar/light source 16 and the movement/vibration source 14, which is shown integrated with energy conversion device 12. In such an embodiment, movement of energy conversion device 12 enables the transformation of the movement/vibrational energy into electrical energy. As described in the foregoing, solar/light source 16 may be a solar panel that generates signals indicative of light received by solar/light source 16. In some embodiments other sources are contemplated. For example, radio-frequency (RF) signals may serve as a source for energy. Accordingly, energy conversion device 12 may be configured to convert these signals into electrical energy.

Additionally, as described above, energy storage device 18 is adapted to store the electrical energy produced by energy conversion device 12. This energy may then be supplied to a vehicle sensor 20b and/or switch 20a. In response, switch 20a and sensor 20b may be engaged/activated to cause functioning of vehicle system via receiving device 22. As described above, in one embodiment, receiving device 22 may be configured to operate as a door module that causes opening and closing of doors 28 and 30 in response to engagement of switch 20a. Alternatively, receiving device 22 may be operable with a keyless entry module or function as a keyless entry module thereby enabling entry into vehicle 26 through the use of a keypad (not shown).

Referring to FIG. 3, a flow chart illustrates a method for providing electrical energy in accordance with an embodiment of the present invention. Block 40 is the entry point into the method. At block 42, the method includes receiving an input. As described above, the input may be provided by movement and/or vibration of the energy conversion device, a solar/light input, a thermal input, an EMI input and the like. Block 44 illustrates a conversion of the received input into electrical energy. As described above, the energy conversion device is configured to convert the received inputs into electrical energy. As depicted by block 46, through the use of the energy storage device, the electrical energy is stored. Accordingly, at block 48 an electrical device may be engaged thereby transmitting signals to the receiving device. In response, the receiving device may perform a function, such as causing the opening of a door, energizing a lamp, and the like. At block 50 the method terminates.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An electrical system for providing electrical energy comprising:
an energy conversion device configured to produce electrical energy from at least one of vibrations and movement experienced by the energy conversion device and light received by the energy conversion device;
an energy storage device coupled to the energy conversion device for storing the electrical energy; and
an electrical device coupled to the energy storage device and configured to receive the electrical energy and transmit a signal to a receiving device.

2. The system of claim 1, wherein the receiving device includes a receiving device configured to cause functioning of at least one of a vehicle door and a keyless entry module.

3. The system of claim 1, wherein the electrical device includes a switch.

4. The system of claim 1, wherein the electrical device includes a sensor.

5. The system of claim 1, wherein the signal transmitted by the electrical device is a radio-frequency (RF) signal.

6. The system of claim 1, wherein the signal transmitted by the electrical device is a signal transmitted through the use of a wire.

7. The system of claim 1, wherein the energy storage device includes at least one of a capacitor and a battery.

8. A method for providing electrical energy comprising:
producing electrical energy from at least one of vibrations and movement experienced by an energy conversion device;
storing the electrical energy through the use of an energy storage device being coupled to the energy conversion device;
receiving the electrical energy through the use of an electrical device being coupled to the energy storage device; and
transmitting a signal to a receiving device upon receiving the electrical energy.

9. The method of claim 8, wherein the receiving device includes a receiving device configured to cause functioning of at least one of a door and a keyless entry module.

10. The method of claim 8, wherein the electrical device includes a switch.

11. The method of claim 8, wherein the electrical device includes a sensor.

12. The method of claim 8, wherein transmitting the signal to a receiving device includes transmitting a radio-frequency (RF) signal.

13. The method of claim 8, wherein transmitting the signal to a receiving device includes transmitting a signal through the use of a wire.

14. The method of claim 8, wherein the energy storage device includes a capacitor.

15. The method of claim 8, wherein the energy storage device includes a battery.

16. An electrical system for providing electrical energy to a vehicle, the system comprising:
an energy conversion device mounted on the vehicle and being configured to produce electrical energy from at least one of vibrations and movement experienced by the energy conversion device, wherein the energy conversion device contains a piezoelectric element that enables conversion of the at least of the vibrations and movement into electrical energy;
an energy storage device coupled to the energy conversion device for storing the electrical energy; and
an electrical device coupled to the energy storage device and configured to receive the electrical energy and transmit a signal to a receiving device, wherein the receiving device causes functioning of a vehicle system.

17. The system of claim 16, wherein the electrical device includes a switch.

18. The system of claim 16, wherein the electrical device includes a sensor.

19. The system of claim 16, wherein the signal transmitted by the electrical device is a radio-frequency (RF) signal.

20. The system of claim 16, wherein the signal transmitted by the electrical device is transmitted through the use of a wire.
